(19) United States
(12) Patent Application Publication
(10) Pub. No.: US 2008/0175466 A1
(43) Pub. Date: Jul. 24, 2008

(54) INSPECTION APPARATUS AND INSPECTION METHOD

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 12/014,755

(22) Filed: Jan. 15, 2008

(30) Foreign Application Priority Data
Jan. 18, 2007 (JP) 2007-009335

(51) Int. Cl. G06K 9/00

(52) U.S. Cl. 382/141

(57) ABSTRACT

An inspection apparatus 1 for detecting a defect on an inspection surface of a sample 2 by inspecting an image captured of the inspection surface, comprises: a defect detection unit 24 for taking as an input the image captured of the inspection surface of the sample 2, and for detecting a defect appearing in the image; a standard defect data storing unit 61 for storing position information of a known standard defect 9 formed in advance on the inspection surface of the actual sample 2; and a detection sensitivity judging unit 50 for judging whether the defect detection unit can detect the standard defect 9 located at the position that the position information stored in the standard defect data storing unit 61 indicates in the image captured of the inspection surface of the sample 2 containing the standard defect 9.

### CROSS REFERENCE TO RELATED APPLICATION

This application is based upon and claims the benefit of priority from prior Japanese Patent Application No. 2007-009335, filed Jan. 18, 2007, the entire contents of which are incorporated herein by reference.

### BACKGROUND OF THE INVENTION

1. Field of the Invention

The present invention relates to an inspection apparatus and inspection method for detecting a defect on an inspection surface of a sample by inspecting an image captured of the inspection surface. More specifically, the invention relates to an inspection apparatus and inspection method for detecting a defect in a pattern formed on the surface of a sample such as a semiconductor wafer, a photomask substrate, a liquid crystal display panel substrate, or a liquid crystal device substrate, based on an image captured of the surface of the sample. The invention also relates to a technique for judging the suitability of defect detection sensitivity in such an inspection apparatus and inspection method.

2. Description of the Related Art

The manufacturing process of a semiconductor device, such as a semiconductor wafer, a photomask substrate, a liquid crystal display panel, or the like, comprises many processing steps, and it is important from the standpoint of improving manufacturing yields to inspect defects at intermediate steps as well as at the final step, and then feed back the results to the manufacturing process. To detect defects during the manufacturing process, visual inspection such as pattern defect inspection is widely practiced which captures an image of a pattern formed on the surface of a sample such as a semiconductor wafer, a photomask substrate, a liquid crystal display panel substrate, or a liquid crystal device substrate, and detects any defects existing on the surface of the sample by inspecting the captured image.

The following description will be given by taking as an example a semiconductor wafer inspection apparatus for inspecting patterns formed on a semiconductor wafer for defects. However, the present invention is not limited to this particular type of apparatus, but can be widely applied to inspection apparatus for inspecting semiconductor devices such as photomask substrates for semiconductor fabrication, liquid crystal device substrates, liquid crystal display panel substrates, and the like.

FIG. 1 shows a block diagram of an inspection apparatus similar to the one that the applicant of this patent application proposed in Japanese Patent Application No. 2003-188209. Generally, inspection apparatus 1 comprises a microscope unit 10 for capturing an image of a semiconductor wafer 2 (hereinafter simply called “wafer 2”) and an image processing unit 20 for detecting a defect existing on the surface of wafer 2 by inspecting the captured image.

Microscope unit 10 is provided with a stage 11 which is movable in two-dimensional directions, and a sample holder (chuck stage) 12 is mounted on the upper surface of stage 11. Wafer 2 as a sample to be inspected is placed on sample holder 12 and held fixed thereon. Stage 11 moves in two-dimensional directions, i.e., in the X and Y directions, under the control of a control signal supplied from a stage control unit 18. Further, by moving sample holder 12 up and down along the Z direction, wafer 2 can be moved in three-dimensional directions.

Microscope unit 10 includes an objective lens 13 through which an optical image of the surface of wafer 2 is projected, and an image capturing unit 14 which captures the optical image of the surface of wafer 2 projected through objective lens 13. Image capturing unit 14 is constructed from an image sensor such as a one-dimensional or two-dimensional CCD camera, preferably a TDI camera, and converts the optical image of the surface of wafer 2 focused on its light receiving surface into an electrical signal.

In the illustrated example, image capturing unit 14 is constructed from a one-dimensional TDI camera. Here, stage control unit 18 moves stage 11 and hence wafer 2 relative to image capturing unit 14 so that image capturing unit 14 scans wafer 2 in the X or Y direction and captures a two-dimensional image of the surface of wafer 2.

Microscope unit 10 further includes a light source 15 and light-gathering lens 16 for illuminating wafer 2, and a half-silvered mirror (beam splitter) 17 placed in the projection light path of objective lens 13. The illuminating light gathered by light-gathering lens 16 is reflected by half-silvered mirror 17 toward objective lens 13, while the optical image of the surface of wafer 2 that objective lens 13 projects toward the light receiving surface of image capturing unit 14 is allowed to pass through half-silvered mirror 7.

Bright-field illumination light is provided to illuminate the surface of wafer 2 from the vertical direction containing the optical axis of objective lens 13, and image capturing unit 14 captures the image of the light specularly reflected at thus illuminated wafer 2.

For simplicity of explanation, the following description will be given by taking as an example an inspection apparatus equipped with a bright-field illumination optical system, but the present invention is not limited to this type of optical system. Some inspection apparatuses employ a dark-field optical system which does not directly capture the illumination light, and the present invention is also applicable to inspection apparatuses equipped with such a dark-field optical system. In the case of dark-field illumination, the wafer is illuminated from an oblique or vertical direction, and a sensor is disposed so as not to detect specularly reflected light. The dark-field image of the surface of the object is then obtained by sequentially scanning the surface with the illumination light. Accordingly, certain types of dark-field apparatuses may not use image sensors, but such types of apparatus also fall within the scope of the present invention.

The image signal output from image capturing unit 14 is converted into a multilevel digital signal (gray level signal), which is then stored in a signal storing unit 21 in image processing unit 20.

As shown in FIG. 2, a plurality of dies (chips) 3 are formed on wafer 2 in a matrix pattern in repeated fashion in the X and Y directions. Since the same pattern is formed on each die, the images captured of these dies should be identical to each other, and therefore, the pixel values of corresponding portions in the captured images should be the same.

Accordingly, by detecting a pixel value difference (gray level difference signal) between corresponding portions in the captured images of any two dies that should normally be identical to each other, the presence or absence of a defect in any one of the dies can be detected, because the gray level difference signal becomes greater when there is a defect in either one of the dies than when there is no defect in either die (die-to-die comparison).

On the other hand, when repeated patterns, such as memory cells, are formed within each die, the presence or absence of a defect can also be detected by detecting a gray level difference between the images captured from the corresponding portions of the repeated patterns that should normally be identical to each other (cell-to-cell comparison).

In a die-to-die comparison, it is general practice to compare the images captured of two adjacent dies (single detection). However, there is no possible way of knowing which die contains the detected defect. Therefore, the die is further compared with a die adjacent on a different side and, if the gray level difference in the same portion is larger than a threshold value, then it is determined that the die under inspection contains the defect (double detection). The same applies to a cell-to-cell comparison.

Referring back to FIG. 1, image processing unit 20 includes a difference detection unit 22 for calculating the gray level difference between corresponding portions in the images captured of any two dies within the image of wafer 2 stored in signal storing unit 21.

As the image capturing unit 14 moves relative to scan wafer 2 under the control of stage control unit 18, output signals from image capturing unit 14 which is a one-dimensional TDI camera are sequentially captured, and the two-dimensional image of wafer 2 is stored in signal storing unit 21.

In the die-to-die comparison, difference detection unit 22 retrieves from signal storing unit 21 sub-images representing corresponding portions of a plurality of adjacent dies based on the position information of stage 11 supplied from stage control unit 18, and takes one of the sub-images as an inspection image and the other as a reference image. Then, a signal representing the gray level difference between the corresponding pixels in the inspection and reference images is computed, and the result is supplied to a detection threshold value calculation unit 23 and a defect detection unit 24.

In the cell-to-cell comparison, difference detection unit 22 likewise retrieves sub-images representing corresponding portions of a plurality of adjacent cells from signal storing unit 21, takes one of the sub-images as an inspection image and the other as a reference image, and computes the gray level difference between them.

Detection threshold value calculation unit 23 determines the detection threshold value based on the distribution of the gray level differences detected by difference detection unit 22, and supplies it to defect detection unit 24.

Defect detection unit 24 detects the presence or absence of a defect in the inspection image by comparing the gray level difference supplied from difference detection unit 22 with the detection threshold value determined by detection threshold value calculation unit 23. More specifically, when the gray level difference signal exceeds the detection threshold value, defect detection unit 24 determines that the inspection image contains a defect at the position of the pixel for which the gray level difference signal was computed.

Then, for each detected defect, defect detection unit 24 creates and outputs defect information which includes such information as the position and size of the detected defect, the gray level difference between the inspection image and the reference image, and the gray level values of these images.

FIG. 3 is a block diagram showing a configuration example of detection threshold value calculation unit 23.

As shown, detection threshold value calculation unit 23 comprises a cumulative frequency computing unit 31 which takes as an input the gray level difference output from difference detection unit 22 and computes its cumulative frequency, a converted cumulative frequency computing unit 32 which takes the cumulative frequency as an input and computes a converted cumulative frequency by converting the cumulative frequency so that the cumulative frequency show a linear relationship to the gray level difference, an approximation straight line computing unit 33 which computes an approximation straight line by approximating the entirety of the converted cumulative frequency by a straight line, and a threshold value determining unit 34 which, based on the approximation straight line, determines the threshold value from a prescribed cumulative frequency value in accordance with a prescribed calculation method.

The operation of thus configured detection threshold value calculation unit 23 and its component elements will be described with reference to FIGS. 4A to 4C. FIGS. 4A to 4C are diagrams explaining how the detection threshold value is calculated by detection threshold value calculation unit 23 shown in FIG. 3.

The gray level difference calculated pixel by pixel by difference detection unit 22 in FIG. 1 is input to cumulative frequency computing unit 31 in FIG. 3. Cumulative frequency computing unit 31 constructs a histogram, such as depicted in FIG. 4A, that shows the distribution of the gray level differences calculated for all the pixels contained in the inspection image and reference image. Here, if the number of pixels to be inspected is large, the histogram need not be constructed by using the gray level differences of all the pixels, but can be constructed by using the gray level differences only of selectively sampled pixels.

Then, cumulative frequency computing unit 31 computes the cumulative frequency of the gray level difference from the histogram.

Next, assuming that the gray level difference input to detection threshold value calculation unit 23 obeys a certain type of distribution, converted cumulative frequency computing unit 32 converts the cumulative frequency calculated by cumulative frequency computing unit 31 so that the cumulative frequency shows a linear relationship to the gray level difference. Here, converted cumulative frequency computing unit 32 converts the cumulative frequency by assuming that the gray level difference obeys a certain type of distribution such as a normal distribution, a Poisson distribution, or a chi-squared distribution. The thus converted cumulative frequency is shown in FIG. 4B.

Then, from the cumulative frequency thus converted by converted cumulative frequency deriving unit 32, approximation straight line deriving unit 33 derives the approximation straight line (y=ax+b) representing the relationship between the gray level difference and the converted cumulative frequency (see FIG. 4C).

Threshold value determining unit 34 determines the threshold value based on the parameters “a” and “b” of the approximation straight line and on sensitivity setting parameters (fixed values). Here, VOP and HO are set as the fixed sensitivity setting parameters for the approximation straight line representing the relationship between the gray level difference and the converted cumulative frequency, and the point on the straight line is obtained which represents cumulative frequency P1 corresponding to a certain cumulative probability (p) (P1 is obtained by multiplying p by the number of samples). Then, the gray level difference obtained by moving that point by VOP in the vertical axis direction and by HO in the horizontal axis direction is taken as the threshold value. Accordingly, threshold value T is calculated by the following equation.

T=(P1−b+VOP)/(a+HO) (1)

In this way, the threshold value can be appropriately determined in accordance with the histogram of the gray level differences of the image under inspection.

With decreasing circuit pattern sizes for semiconductor devices in recent years, there has been a need to enhance the defect detection sensitivity of inspection apparatuses so as to be able to accurately detect microscopic defects.

The defect detection sensitivity of an inspection apparatus depends on the inspection conditions used in the inspection apparatus, such as optical conditions (for example, the intensity of illumination light, the focus position of a focusing optical system, etc.) for an optical system such as microscope unit 10 and defect detection conditions (for example, the abovementioned detection threshold used for the detection of a defect, etc.) for defect detection unit 24.

If inspection is performed without properly setting the inspection conditions, defects that can normally be detected by the inspection apparatus may go undetected. In this case, it is not possible to determine if there are any defects on the sample even if defects have not been detected, since there is a possibility that the inspection conditions have not been set properly.

In the prior art, it is standard practice to check the apparatus conditions at regular intervals, for example, once a day before inspection, by performing visual inspection using the same dummy wafer every time and by just verifying that the apparatus conditions are the same as those when they were checked last time. This is because if all adjustable parts are checked at frequent intervals, the whole task would become extremely laborious, requiring checking a large number of parts that would affect the detection sensitivity of the inspection apparatus.

However, the inspection conditions used in the visual inspection differ depending on the wafer to be inspected. Example of the inspection conditions that differ include the wavelength of the light used as the illumination light and the layer to be inspected. In the prior art inspection is performed without knowing whether the inspection conditions, such as the optical conditions and detection conditions, that have been set by using the dummy wafer before the inspection are appropriate ones for the individual wafer to be inspected.

### SUMMARY OF THE INVENTION

In view of the above problem, it is an object of the present invention to provide an inspection apparatus and inspection method that can judge whether the currently set inspection condition is suitable for the inspection of the actual sample to be inspected.

To achieve the above object, in the present invention, a known defect is formed in advance on the actual sample to be inspected, and it is judged whether this defect can be detected using the currently set inspection condition. The known defect thus formed on the actual sample to be inspected will be referred to as the “standard defect.”

More specifically, if the standard defect formed in advance on the actual sample can be detected, then it can be ensured that the inspection performed on the sample has been done with a detection sensitivity at least good enough to detect defects comparable in size to the standard defect.

According to a first aspect of the present invention, there is provided an inspection apparatus for detecting a defect on an inspection surface of a sample by inspecting an image captured of the inspection surface. The inspection apparatus comprises: a defect detection unit for taking as an input the image captured of the inspection surface of the sample, and for detecting a defect appearing in the image; a standard defect data storing unit for storing position information of a known standard defect formed in advance on the inspection surface of the sample to be inspected; and a detection sensitivity judging unit for judging whether the defect detection unit can detect the standard defect located at the position that the position information stored in the standard defect data storing unit indicates in the image captured of the inspection surface of the sample containing the standard defect.

For example, the defect detection unit may be configured so that when, in the image captured of the inspection surface of the sample, a gray level difference detected between corresponding portions that should normally be identical to each other satisfies a prescribed detection condition, the corresponding portions are detected as defect candidates. In this case, the detection sensitivity judging unit judges whether the standard defect can be detected by the defect detection unit, based on whether or not a standard defect gray level difference, which is a gray level difference occurring between a portion containing the standard defect and another portion in the image captured of the inspection surface of the sample containing the standard defect, satisfies the prescribed detection condition.

Additionally, when the defect detection unit is configured, for example, to output defect information containing position information of the detected defect, the detection sensitivity judging unit judges whether the standard defect has been detected by the defect detection unit, by comparing the position information contained in the defect information concerning the defect that the defect detection unit detected from the image captured of the inspection surface of the sample containing the standard defect with the position information stored in the standard defect data storing unit.

According to a second aspect of the present invention, there is provided an inspection method having a defect detection step for detecting a defect on an inspection surface of a sample by inspecting an image captured of the inspection surface. The method comprises: a standard defect data storing step for storing position information of a known standard defect formed in advance on the inspection surface of the sample to be inspected; an image capturing step for capturing the image of the inspection surface of the sample containing the standard defect; and a detection sensitivity judging step for judging whether the standard defect located at the position that the position information stored in the standard defect data storing step indicates in the image captured in the image capturing step can be detected in the defect detection step.

### BRIEF DESCRIPTION OF THE DRAWINGS

The present invention will be more clearly understood from the description as set below with reference to the accompanying drawings, wherein:

FIG. 1 is a block diagram of an inspection apparatus according to the prior art;

FIG. 2 is a diagram showing an arrangement of dies on a semiconductor wafer;

FIG. 3 is a block diagram showing a configuration example of a detection threshold value calculation unit;

FIGS. 4A to 4C are diagrams for explaining how a detection threshold value is calculated by the detection threshold value calculation unit shown in FIG. 3;

FIG. 5 is a general block diagram of an inspection apparatus according to a first embodiment of the present invention;

FIG. 6 is a block diagram showing a configuration example of a microscope unit shown in FIG. 5;

FIG. 7 is a block diagram showing a configuration example of an image processing unit shown in FIG. 5;

FIG. 8 is a diagram showing an example of an arrangement of standard defects;

FIG. 9A is an enlarged view of an example of the original pattern formed on the surface of a wafer 2;

FIG. 9B is a diagram showing standard defects formed on the pattern of FIG. 9A;

FIG. 10 is a block diagram showing a configuration example of a detection sensitivity judging unit shown in FIG. 5;

FIG. 11 is a flowchart of a detection sensitivity judging method according to a first embodiment of the present invention;

FIGS. 12A and 12B are diagrams for explaining the detection sensitivity judging method of FIG. 11;

FIG. 13 is a diagram explaining one example of a method of determining a standard defect gray level difference;

FIG. 14 is a general block diagram of an inspection apparatus according to a second embodiment of the present invention;

FIG. 15 is a block diagram showing a configuration example of a microscope unit shown in FIG. 14;

FIG. 16 is a block diagram showing a configuration example of an image processing unit shown in FIG. 14;

FIG. 17 is a block diagram showing a configuration example of a detection sensitivity judging unit shown in FIG. 14; and

FIG. 18 is a flowchart of a detection sensitivity judging method according to a second embodiment of the present invention.

### DESCRIPTION OF THE PREFERRED EMBODIMENTS

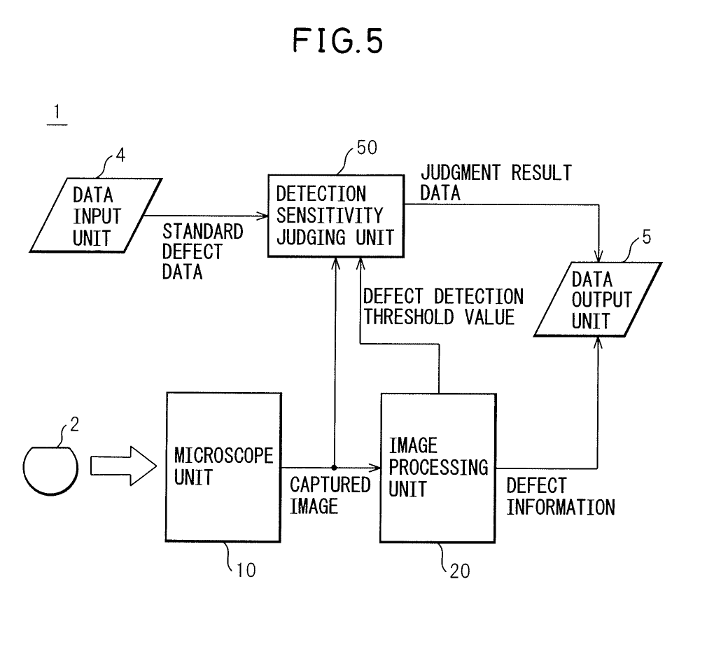

Preferred embodiments of the present invention will be described in detail below while referring to the attached figures. FIG. 5 is a general block diagram of an inspection apparatus according to a first embodiment of the present invention. Inspection apparatus 1 comprises: a microscope unit 10 as an optical system for acquiring an image by capturing an optical image of the surface of actual wafer 2 to be inspected; an image processing unit 20 which takes as an input the image captured by microscope unit 10 and detects a defect appearing in the captured image; and a detection sensitivity judging unit 50.

Here, detection sensitivity judging unit 50 has the function of judging whether or not inspection apparatus 1 has the desired defect detection sensitivity when image processing unit 20 has performed processing using a prescribed defect detection condition to detect a defect in the image that microscope unit 10 captured the surface of any particular wafer 2 under a prescribed optical condition. Image processing unit 20 and detection sensitivity judging unit 50 may be implemented using a computer or the like that performs data processing and mathematical operations.

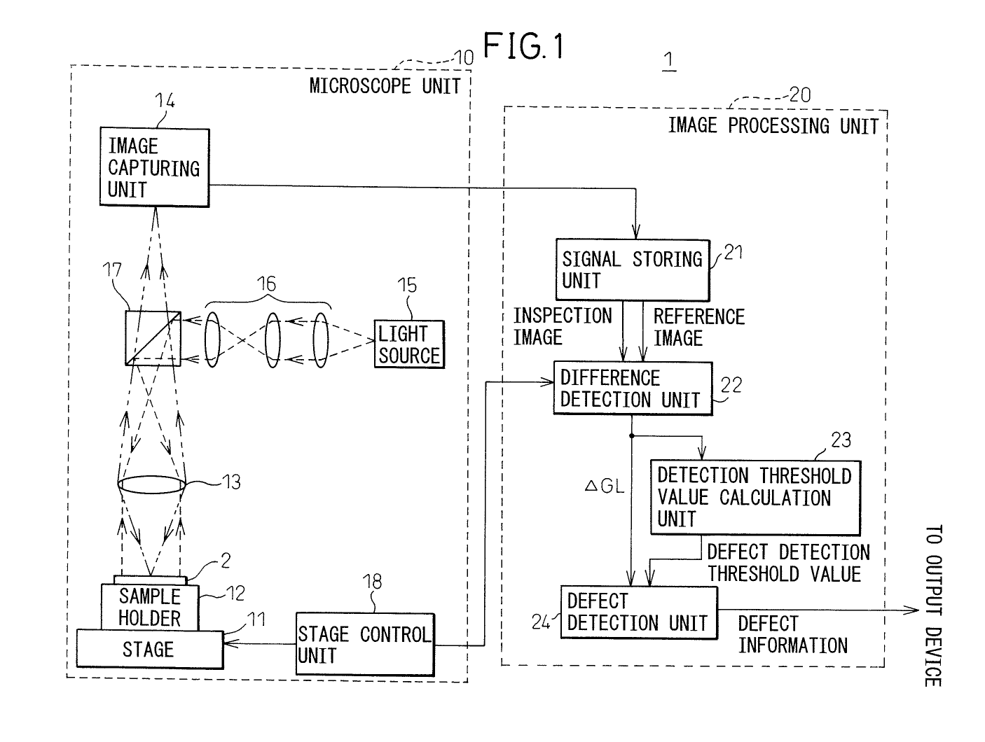

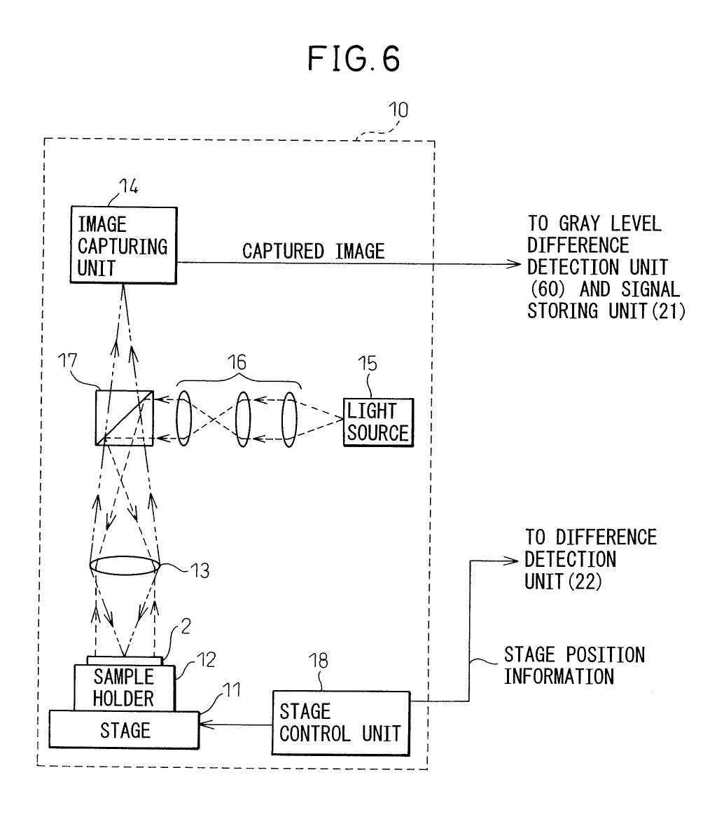

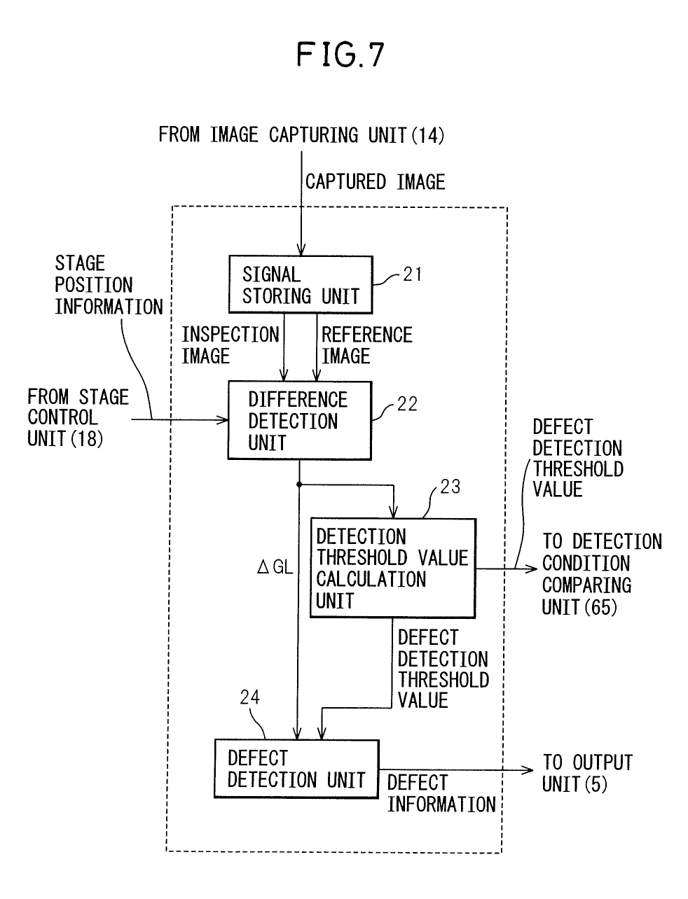

FIG. 6 is a block diagram showing a configuration example of microscope unit 10 shown in FIG. 5, and FIG. 7 is a block diagram showing a configuration example of image processing unit 20. Microscope unit 10 and image processing unit 20 shown in FIGS. 6 and 7, respectively, are similar in configuration to the corresponding units in the inspection apparatus previously described with reference to FIG. 1, therefore, the same component elements are designated by the same reference numerals, and the description of the same functions will not be repeated here.

In the following description, as an example of the optical condition that affects the defect detection sensitivity of inspection apparatus 1, the amount of light to be emitted from light source 15 shown in FIG. 6 is considered. Further, as an example of such an optical condition, the focusing condition is considered that can be adjusted by moving stage 11 and hence sample holder 12 up and down thereby changing the relative distance between wafer 2 and the focusing optical system including objective lens 13.

On the other hand, as an example of the defect detection condition of image processing unit 20 that affects the defect detection sensitivity of inspection apparatus 1, detection threshold value T is considered with which the gray level difference (ΔGL) output from difference detection unit 22 is compared when detecting a defect using defect detection unit 24 shown in FIG. 7.

In this patent specification, the setup conditions of inspection apparatus 1, such as the optical condition of microscope unit 10 and the detection condition of image processing unit 20, that affect the detection sensitivity of inspection apparatus 1 may be collectively referred to as the “inspection conditions.”

When a wafer with prescribed standard defects formed on its inspection surface is loaded as a sample to be inspected into inspection apparatus 1, detection sensitivity judging unit 50 judges whether or not inspection apparatus 1 has the desired defect detection sensitivity based on an image captured of the inspection surface of the sample captured by microscope unit 10.

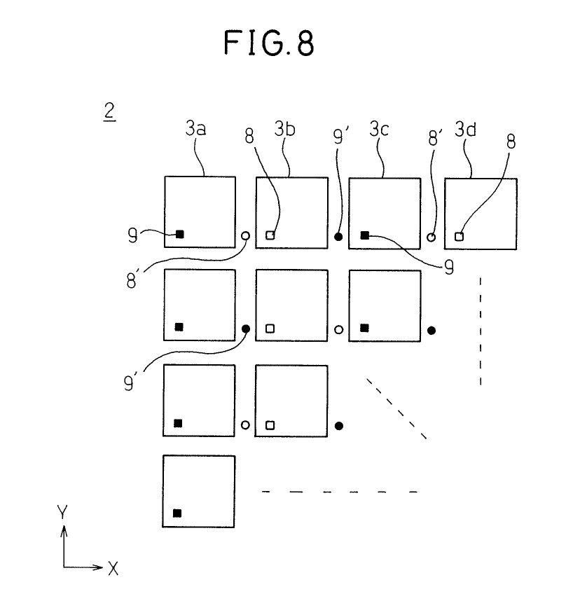

FIG. 8 shows an example of an arrangement of the standard defects. A plurality of dies 3a, 3b, 3c, 3d, . . . are formed on the surface of wafer 2 in a matrix pattern in repeated fashion in the X and Y directions. Standard defects 9 indicated by filled squares are provided, for example, one for every two or more dies that are arranged in repeated fashion. Unfilled squares 8 indicate normal pattern portions to be compared with standard defects 9 in a die-to-die comparison.

When standard defects 9 are provided in this manner, then when a die-to-die comparison is made between adjacent dies, for example, dies 3a and 3b, standard defect 9 formed on die 3a can be detected in the same manner as when detecting an actual defect, because the gray level of the image captured from the portion of standard defect 9 on die 3a substantially differs from that of the image captured from the corresponding portion on other die 3b (i.e., the position on die 3b that corresponds to the position on die 3a at which standard defect 9 is formed).

The standard defects may also be formed as shown by filled circles 9′ in the dicing space outside the dies. Unfilled circles 8′ indicate normal pattern portions to be compared with standard defects 9′ in a die-to-die comparison. By providing standard defects 9′ one for every two or more dies not only in the X direction but also in the Y direction, standard defects 9′ can be detected whether the die-to-die comparison is performed in the X direction or the Y direction.

In a manner similar to the above, when determining inspection conditions for cell-to-cell comparison inspection, standard defects 9 are provided one for every two or more cells.

When providing more than one standard defect 9 on one inspection surface, standard defects 9 need not be limited to one specific kind, but multiple kinds of standard defects 9 differing in size and shape may be provided.

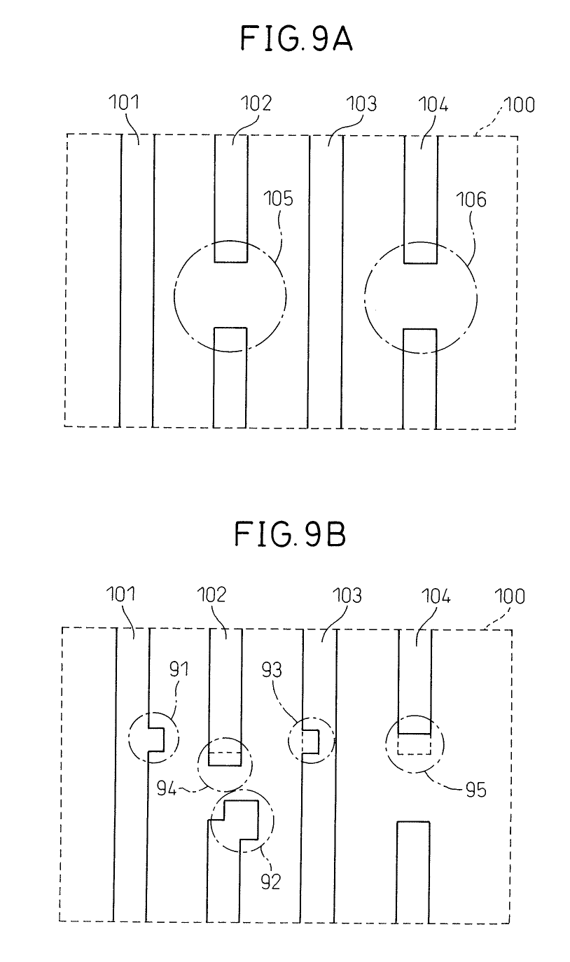

FIG. 9A is an enlarged view of a pattern formed on the surface of wafer 2, i.e., the original pattern that does not contain any standard defects, and FIG. 9B is a diagram showing standard defects formed on the pattern of FIG. 9A.

As shown in FIG. 9A, the pattern formed in a given region 100 on the surface of wafer 2 comprises a plurality of conductive circuit lines 101 to 104, of which line 102 has a cut portion at the position indicated by reference numeral 105 while line 104 has a cut portion at the position indicated by 106.

The standard defects here may be formed as microscopic defects with conductive portions overflowing from the original regions of conductive lines 101 and 102, as shown, for example, at positions 91 and 92 in FIG. 9B. Further, the standard defects may be formed as microscopic defects with conductive portions partially eroded, such as a portion 93 where a portion of conductive line 103 is eroded.

Alternatively, the standard defects may be formed by extending or shortening the line length as shown in portions 94 and 95.

It is desirable that standard defects 91 to 95 be formed so as to have the minimum dimensions, i.e., minimum width, minimum length, etc. that should be managed in the semiconductor process. By providing the standard defects of such dimensions, it becomes possible to judge whether or not minimum defects that can affect manufacturing yields in the manufacturing process can be detected. Standard defects 91 to 95 may be formed in the same manufacturing process in which the patterns to be inspected are formed on the surface of wafer 2. Alternatively, the standard defects may be formed on the surface of wafer 2 before or after forming the patterns to be inspected.

Turning back to FIG. 5, inspection apparatus 1 further comprises a data input unit 4 for entering various data that is necessary for the operation of inspection apparatus 1. Data input unit 4 may include any one of input devices selected from the group consisting, for example, of a user interface such as a keyboard, mouse, touch panel, etc., that an operator uses to input data, a removable media reading device, such as a flexible disk drive, a CD-ROM drive, or a memory reading device, for reading data provided in the form of a removable medium such as a flexible disk, a CD-ROM, or a memory card, and an interface device for inputting the data on-line.

Data input unit 4 is also used to input standard defect data concerning standard defect 9 formed on wafer 2 to detection sensitivity judging unit 50. The standard defect data includes at least die designation information designating the die in which standard defect 9 is provided and position information of standard defect 9 indicating the position on the die at which standard defect 9 is formed. If the standard defect data includes data concerning more than one standard defect 9, identifier information for identifying each individual standard defect 9 may be included.

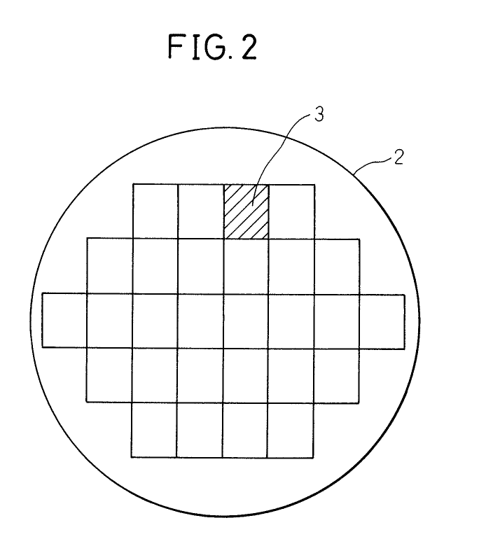

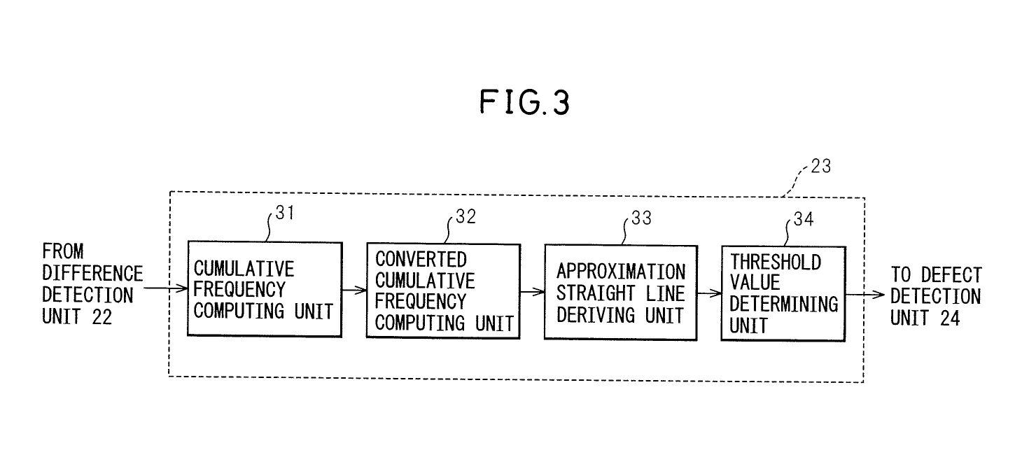

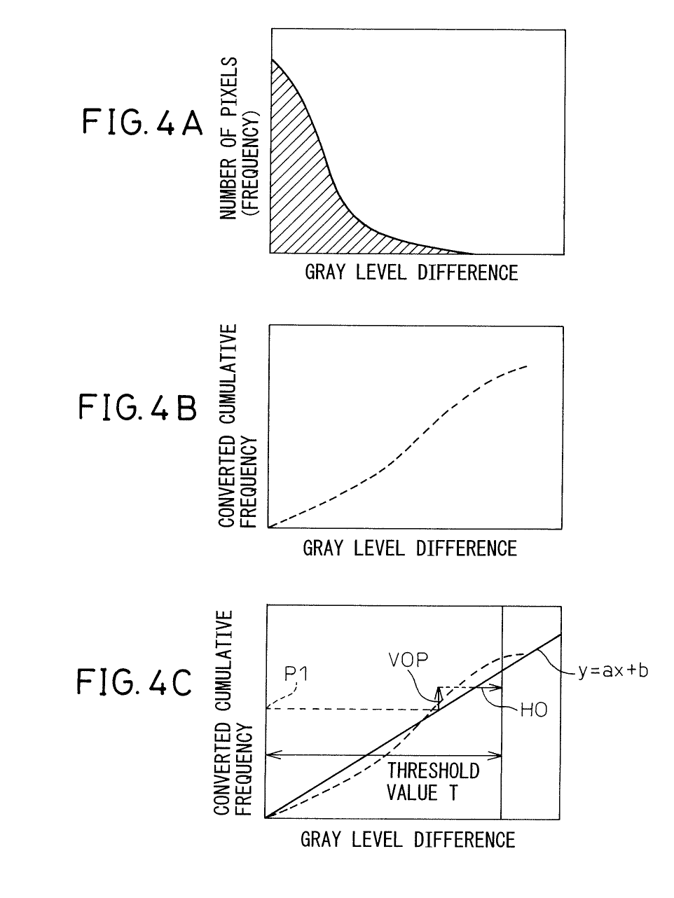

Turning back to FIG. 5, when the image of the surface of wafer 2 containing standard defect 9 is captured by microscope unit 10, and the captured image is input to signal processing unit 20, image processing unit 20 shown in FIG. 7 detects defects on the surface of wafer 2 by using signal storing unit 21, difference detection unit 22, detection threshold value calculation unit 23, and defect detection unit 24, as in the inspection method previously described with reference to FIGS. 1 to 3 and 4A to 4C, and creates defect information for each detected defect; the thus created defect information is output from image processing unit 20. The defect information to be output here includes defect information created by detecting standard defect 9.

The defect information output from image processing unit 20 is output outside inspection apparatus 1 via a data output unit 5 which is shown in FIG. 5.

Data output unit 5 may include any one of output devices selected from the group consisting, for example, of a display device such as a CRT or a liquid crystal display panel on which the data to be output is displayed for viewing by the operator, a printer for printing the data on a paper medium, a removable media writing device, such as a flexible disk drive, a CD-ROM drive, or a memory writing device, for storing the data to be output and writing the data to a removable medium such as a flexible disk, a CD-ROM, or a memory card, and an interface device for outputting the data on-line.

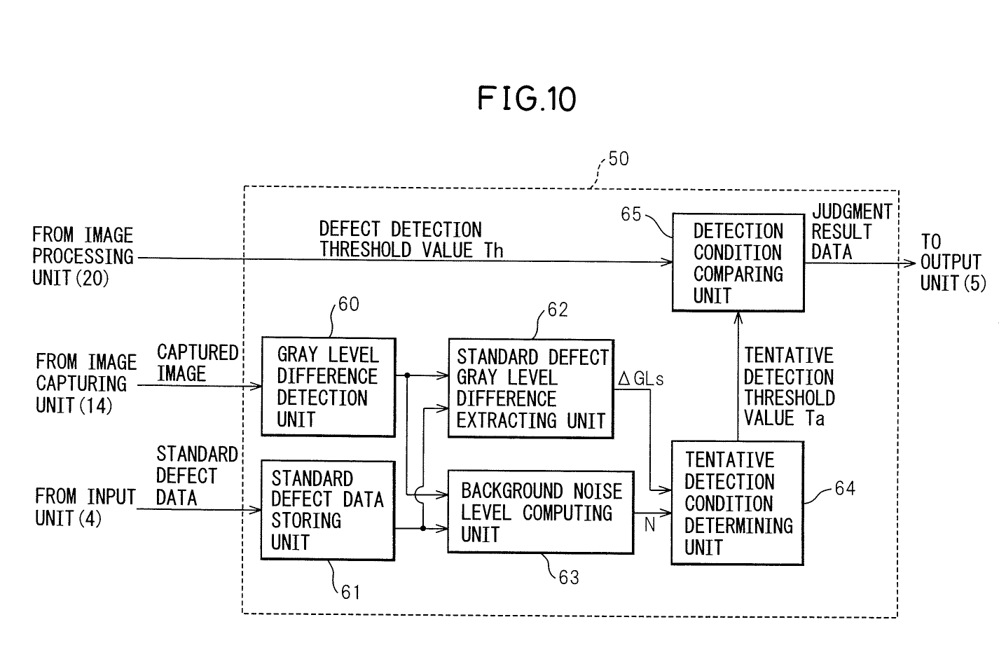

FIG. 10 is a block diagram showing a first configuration example of detection sensitivity judging unit 50 shown in FIG. 5. As shown, detection sensitivity judging unit 50 comprises a gray level difference detection unit 60, a standard defect data storing unit 61, a standard defect gray level difference extracting unit 62, a background noise level computing unit 63, a tentative detection condition determining unit 64, and a detection condition comparing unit 65.

Gray level difference detection unit 60 receives from image capturing unit 14 the image captured of the surface of wafer 2 containing the standard defect, and detects the gray level difference between corresponding portions in the captured image that should normally be identical to each other, in the same manner as difference detection unit 22 previously described with reference to FIG. 1.

Standard defect data storing unit 61 stores the standard defect data input via input unit 4. The standard defect data stored in standard defect data storing unit 61 includes at least the position information indicating the position at which the standard defect is provided.

Based on the position information of the standard defect stored in standard defect data storing unit 61, standard defect gray level difference extracting unit 62 extracts, from among the gray level differences detected by gray level difference detection unit 60, the gray level difference detected for the portion of the standard defect, that is, standard gray level difference ΔGLs.

Likewise, based on the position information of the standard defect stored in standard defect data storing unit 61, background noise level computing unit 63 extracts, from among the gray level differences detected by gray level difference detection unit 60, the gray level differences detected for other portions than the standard defect, that is, the gray level differences for the background, and computes noise level N of the background of the captured image input to detection sensitivity judging unit 50.

Tentative detection condition determining unit 64 determines a tentative detection threshold value Ta based on standard gray level difference ΔGLs extracted by standard defect gray level difference extracting unit 62 and on noise level N computed by background noise level computing unit 63.

Tentative detection threshold value Ta is determined in accordance with a prescribed determination method to be described later so that when a gray level difference larger than standard gray level difference ΔGLs occurs between corresponding portions in the captured image that should normally be identical to each other, tentative detection threshold value Ta provides a threshold value suitable for detecting such corresponding portions as defect candidates.

Detection condition comparing unit 65 receives from defect threshold value calculation unit 23 in image processing unit 20 defect detection threshold value Th currently used for defect detection by defect detection unit 24, and compares defect detection threshold value Th with tentative detection threshold value Ta determined by tentative detection condition determining unit 64. Then, when the difference or ratio between Ta and Th is within a predetermined acceptable range ΔT, detection condition comparing unit 65 judges that the detection sensitivity of inspection apparatus 1 is good, but when the difference or ratio between Ta and Th is outside predetermined acceptable range ΔT, then it is judged that the detection sensitivity of inspection apparatus 1 is outside the acceptable range. Detection condition comparing unit 65 supplies judgment result data indicating the result of the judgment to output unit 5.

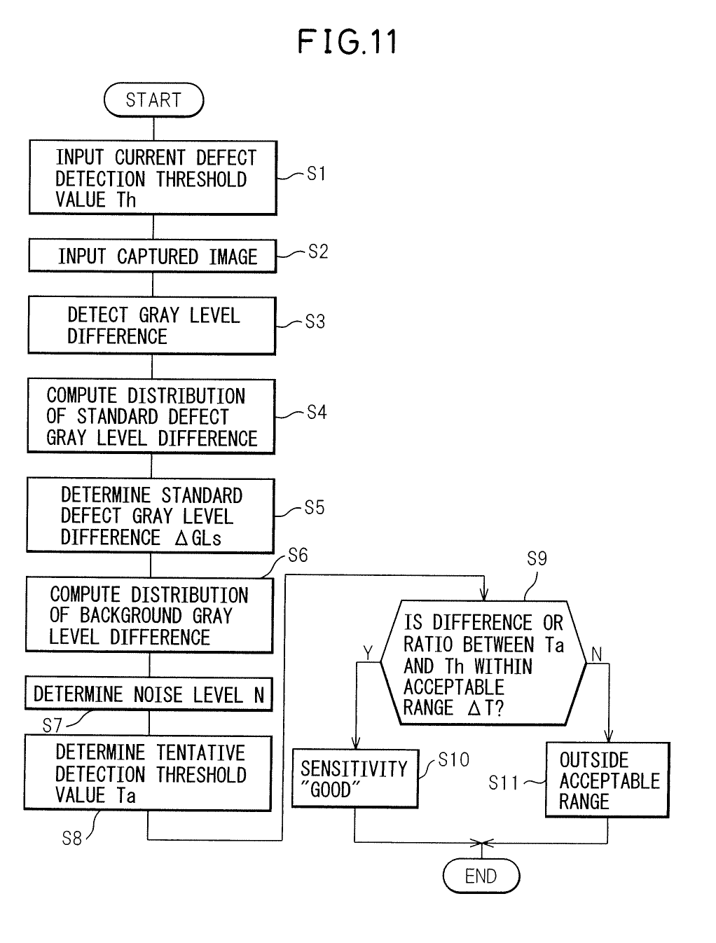

FIG. 11 is a flowchart of a detection sensitivity judging method according to a first embodiment of the present invention, showing how detection sensitivity judging unit 50 shown in FIG. 10 judges the suitability of the detection sensitivity of inspection apparatus 1.

In step S1, detection condition comparing unit 65 receives from defect threshold value calculation unit 23 in image processing unit 20 defect detection threshold value Th currently used for defect detection by defect detection unit 24. In step S2, the image captured of the surface of wafer 2 containing the standard defect is input from image capturing unit 14 to gray level difference detection unit 60.

In step S3, gray level difference detection unit 60 detects the gray level difference between corresponding portions in the captured image that should normally be identical to each other. Here, for example, gray level difference detection unit 60 may detect the gray level difference between the inspection image and its corresponding reference image that difference detection unit 22 in FIG. 1 or 7 uses when comparing patterns in the earlier described die-to-die comparison or cell-to-cell comparison.

In step S4, standard defect gray level difference extracting unit 62 extracts, from among the gray level differences detected by gray level difference detection unit 60, the gray level difference detected for the portion of the standard defect, i.e., standard gray level difference ΔGLs.

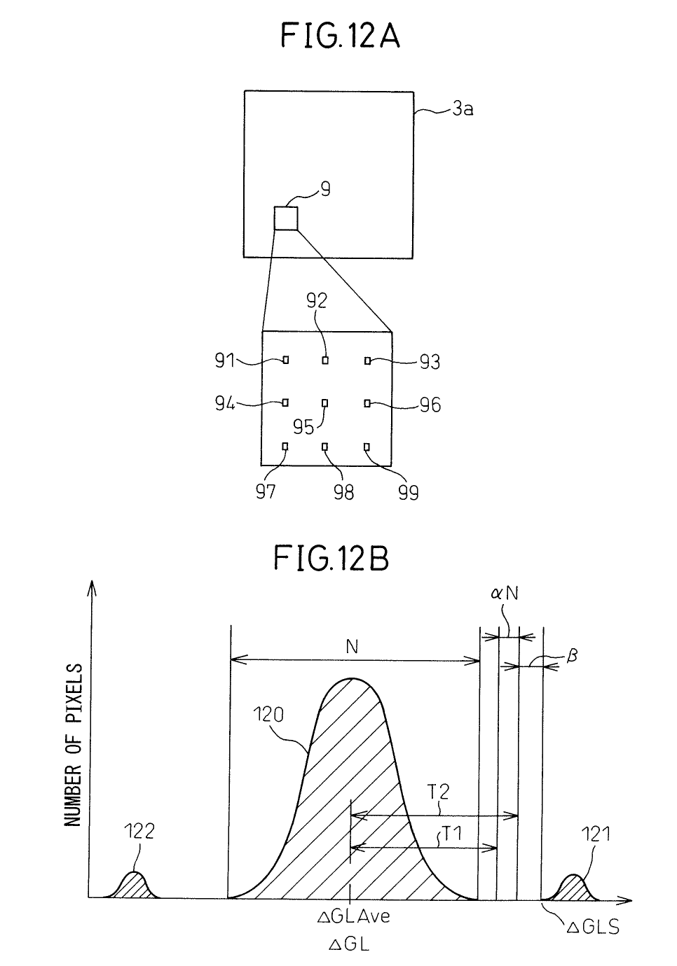

Here, standard defect gray level difference extracting unit 62 reads out the position information of the standard defect stored in standard defect data storing unit 61, and extracts only the gray level difference detected for the pixel containing the standard defect from among the gray level differences detected between corresponding pixels by gray level difference detection unit 60. This will be explained with reference to FIGS. 12A and 12B.

FIG. 12A is a diagram showing a die 3a with standard defects 91 to 99 formed in a region 9 thereof. When gray level differences are detected between die 3a and its adjacent die with no standard defects formed thereon, the distribution of gray level differences ΔGL detected in region 9 containing standard defects 91 to 99 is as shown in FIG. 12B. Here, ΔGLAve indicates the average value of the gray levels in region 9.

In the gray level difference distribution shown in FIG. 12B, portion 120 containing the center of the distribution represents the distribution of the background gray level differences detected for the pixels located within region 9, except those pixels containing standard defects 91 to 99, while portions 121 and 122 where the absolute gray level differences are larger than the gray level differences detected in portion 120 represent the distributions of the gray level differences detected for standard defects 91 to 99.

Based on the standard defect position information stored in standard defect data storing unit 61, standard defect gray level difference extracting unit 62 extracts only the gray level differences detected for the pixels containing the standard defects, thereby obtaining the gray level difference distributions as shown in portions 121 and 122.

In step S5, standard defect gray level difference extracting unit 62 determines a representative value representing the gray level differences having the distributions shown in portions 121 and 122, and takes it as standard defect gray level difference ΔGLS.

Standard defect gray level difference ΔGLs is used in a subsequent step as a value based on which to determine tentative detection threshold value Ta. Detection threshold value Ta is set so that when it is used as the defect detection threshold value by defect detection unit 24 shown in FIG. 7, defect detection unit 24 can detect all standard defects 91 to 99. Accordingly, standard defect gray level difference extracting unit 62 determines standard defect gray level difference ΔGLs, based on distributions shown in portions 121 and 122 occurring due to standard defects 91 to 99.

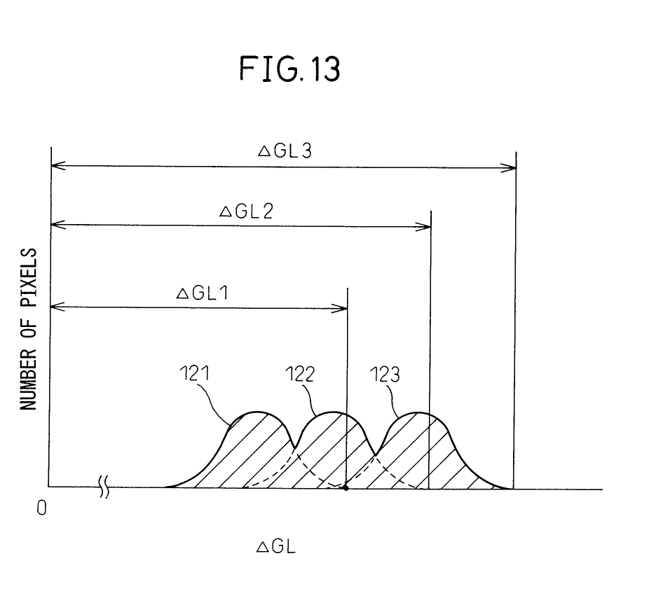

A method of determining standard defect gray level difference ΔGLs will be described with reference to FIG. 13. Standard defect gray level difference extracting unit 62 may obtain representative values representing the gray level differences detected for respective standard defects 91 to 99 used for determining standard defect gray level difference ΔGLs, and may take the smallest of these representative values as standard defect gray level difference ΔGLs.

In the example of FIG. 13, the maximum values in gray level difference distributions 121 to 123 respectively detected for three standard defects are taken as representative values ΔGL1, ΔGL2, and ΔGL2, respectively, of which smallest value ΔGL1 is determined as standard defect gray level difference ΔGLs.

Since each pixel in the captured image varies according to the noise level of the image, it is preferable to provide a margin for tentative detection threshold value Ta in accordance with the noise level. Here, the noise level can be assumed to be a quantity proportional to the variance of the background.

Accordingly, in step S6, background noise level computing unit 63 extracts, from among the gray level differences detected by gray level difference detection unit 60, the gray level differences detected for other portions than the standard defects, i.e., the gray level differences for the background. The distribution of the thus extracted gray level differences is as shown in portion 120 in FIG. 12B.

In step S7, background noise level computing unit 63 computes noise level N of the background of the captured image input to detection sensitivity judging unit 50. Noise level N here may be determined, for example, as the variance of the background gray level differences extracted in step S6, or simply as the width of the distribution of the gray level differences detected for other portions than the standard defects.

In step S8, tentative detection condition determining unit 64 calculates a value T1 by subtracting a margin (α×N)+β appropriate to noise level N computed by background noise level computing unit 63, from standard defect gray level difference ΔGLs extracted by standard defect gray level difference extracting unit 62, that is,

T1=ΔGLs−(α×N)−β (2)

and determines this value as tentative detection threshold value Ta. Here, α and β are predetermined constants.

Or more simply, condition determining unit 64 calculates a value T2 by simply subtracting a prescribed margin β from standard defect gray level difference ΔGLs, that is

T2=ΔGLs−β (3)

and determines this value as tentative detection threshold value Ta. The relationship between standard defect gray level difference ΔGLs and values T1 and T2 each adopted as tentative detection threshold value Ta is shown in FIG. 12B.

In step S9, detection condition comparing unit 65 compares tentative detection threshold value Ta calculated in step S8 with the current defect detection threshold value Th received in step S1. If the difference or ratio between Ta and Th is within predetermined acceptable range ΔT, detection condition comparing unit 65 judges in step S10 that the detection sensitivity of inspection apparatus 1 is good, but if the difference or ratio between Ta and Th is outside predetermined acceptable range ΔT, detection condition comparing unit 65 judges in step S11 that the detection sensitivity of inspection apparatus 1 is outside the acceptable range.

When value T1 is adopted as tentative detection threshold value Ta, the width of acceptable range ΔT is set smaller than margin (α×N)+β; on the other hand, when value T2 is adopted as tentative detection threshold value Ta, it is set smaller than margin β. Accordingly, when it is judged in step S10 that the detection sensitivity of inspection apparatus 1 is good, defect detection unit 24 can detect all standard defects 91 to 99 by using the current defect detection sensitivity Th.

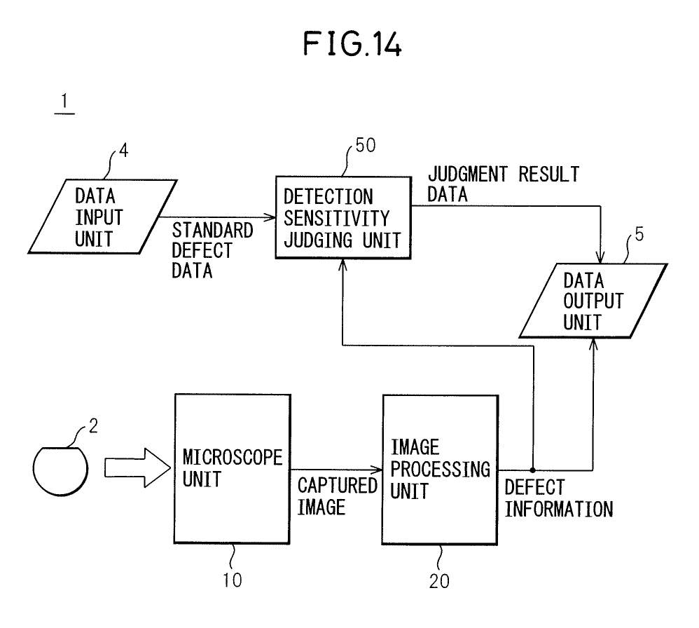

FIG. 14 is a general block diagram of an inspection apparatus 1 according to a second embodiment of the present invention. Inspection apparatus 1 shown in FIG. 14 is similar in configuration to inspection apparatus 1 shown in FIG. 5, therefore, the same component elements are designated by the same reference numerals, and the description of the same functions will not be repeated here.

In this embodiment, image processing unit 20 detects the standard defect formed on wafer 2 and, based on the defect information created by image processing unit 20, sensitivity detection judging unit 50 judges whether or not inspection apparatus 1 has the desired defect detection sensitivity.

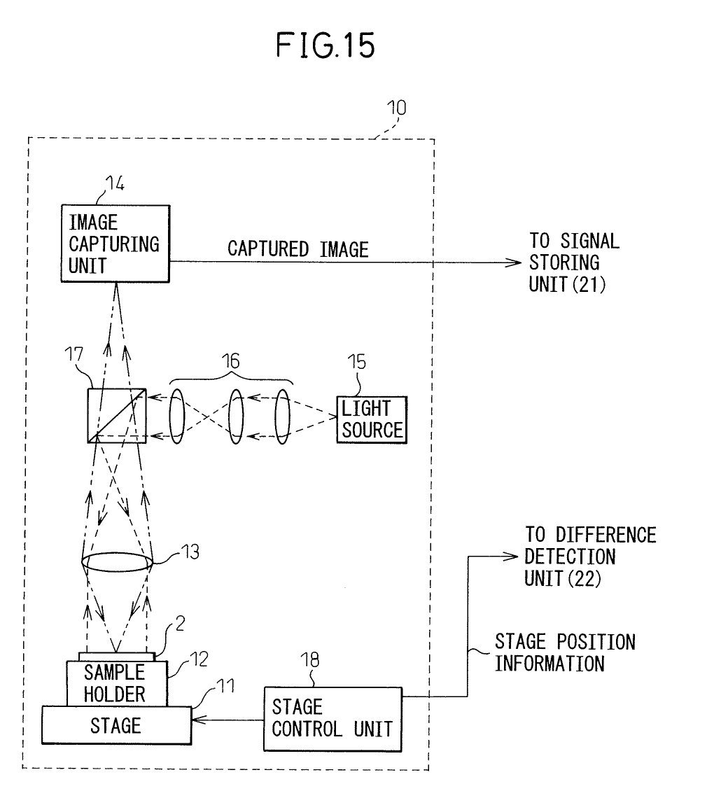

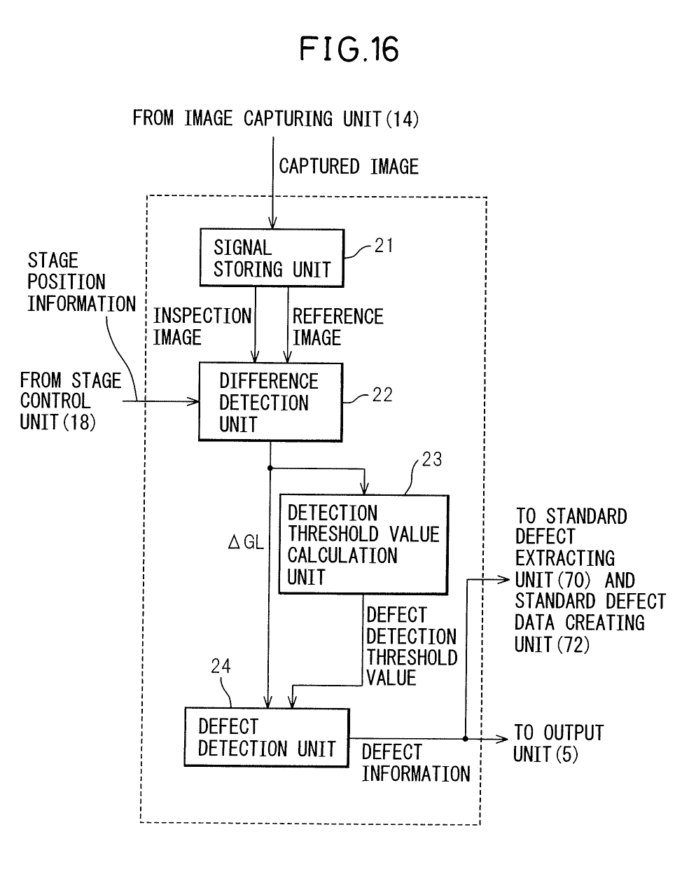

FIGS. 15 and 16 are block diagrams respectively showing configuration examples of microscope unit 10 and image processing unit 20 shown in FIG. 14. Since microscope unit 10 and image processing unit 20 are similar in configuration to microscope unit 10 and image processing unit 20 previously shown in FIGS. 6 and 7, respectively, the same component elements are designated by the same reference numerals, and the description of the same functions will not be repeated here.

In this embodiment, defect detection unit 24 outputs the defect information by including therein a predefined kind of evaluated value representing the result of the comparison between the inspection image and the reference image, i.e., between corresponding portions in the captured image that should normally be identical to each other, which are compared by difference detection unit 22.

Here, a value that changes in accordance with the extent of the difference between the inspection image and the reference image in the defect portion is chosen as the evaluated value. Defect detection unit 24 may include as the evaluated value in the defect information a value representing, for example, the gray level difference occurring between the inspection image and the reference image at the detected position of the defect or the size of the detected defect.

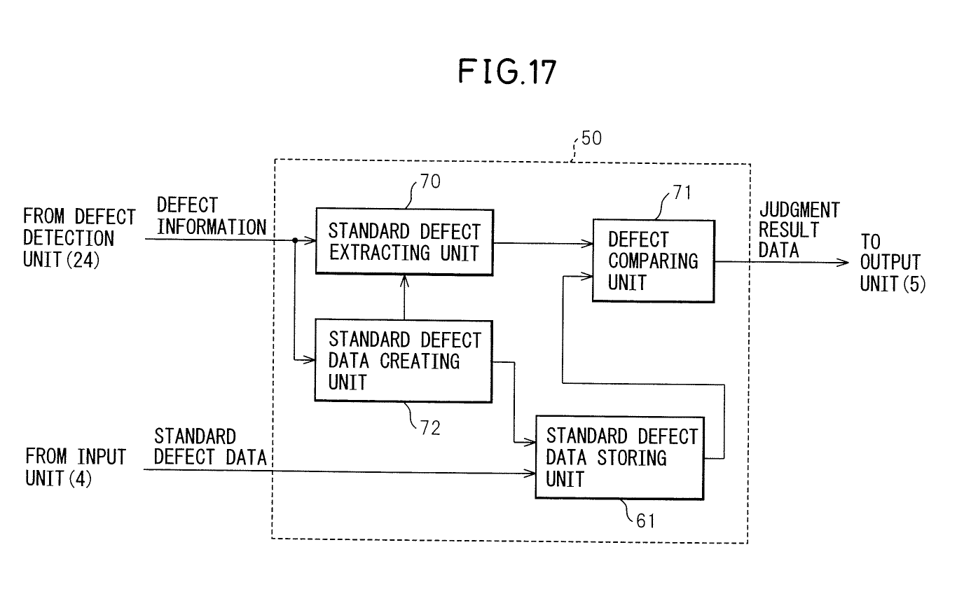

FIG. 17 is a block diagram showing a configuration example of detection sensitivity judging unit 50 shown in FIG. 14. As shown, detection sensitivity judging unit 50 comprises a standard defect data storing unit 61, a standard defect extracting unit 70, and a defect comparing unit 71.

As in the configuration of detection sensitivity judging unit 50 shown in FIG. 10, standard defect data storing unit 61 stores the standard defect data input via input unit 4. The standard defect data stored in standard defect data storing unit 61 includes at least the position information indicating the position at which the standard defect is provided. In this embodiment, the standard defect data further includes a target evaluated value which is set for being used for a target of the predefined kind of evaluated value included in the defect information output from defect detection unit 24 for the standard defect.

The target evaluated value is a value such that the yardstick by which to measure how much the difference occurring between the inspection image and the reference image at the portion of the standard defect differs from the originally expected difference can be determined in accordance with the extent of the difference between the target evaluated value and the predefined kind of evaluated value included in the defect information output for the standard defect. To give an example of such an evaluated value, when the predefined kind of evaluated value is the gray level difference occurring between the inspection image and the reference image at the detected position of the defect, the gray level difference detected between images captured from the surface of wafer 2 by image capturing unit 14, one representing the portion where the standard defect is formed and the other the same portion but without forming the standard defect thereon, may be taken as the target evaluated value. On the other hand, when the predefined kind of evaluated value is the size of the detected defect, the size of the standard defect may be taken as the target evaluated value.

The target evaluated value may be externally supplied to detection sensitivity judging unit 50 via data input unit 4, or may be computed in image processing unit 20 by using the images captured by microscope unit 10 in inspection apparatus 1. Inspection condition setting unit 50 in the illustrated example includes a standard defect data creating unit 72 which receives the defect information output from defect detection unit 24, and creates the standard defect data containing the target evaluated value.

The standard defect data is created, for example, in the following manner. First, the defect detection is performed several times by changing the inspection conditions, and inspection apparatus 1 is set in a condition that can accurately detect the standard defect. Then, in this condition, the defect information output from defect detection unit 24 is input to standard defect data creating unit 72.

Based on the position information of the standard defect stored in standard defect data storing unit 61, standard defect data creating unit 72 extracts the defect information concerning the standard defect from among the defect information thus input.

The defect information output from defect detection unit 24 contains the evaluated value created based on the difference detected between the inspection image and the reference image at the position of the detected defect. Standard defect data creating unit 72 acquires the evaluated value contained in the defect information of the standard defect detected under suitable detection conditions, and stores it as the target evaluated value in standard defect data storing unit 61.

For example, when the standard defect data is created by including therein the above-described gray level difference as the predefined kind of target evaluated value, the gray level difference detected between the inspection image and the reference image at the position of the standard defect is included as the evaluated value.

Here, the standard defect exists in either one of the images, the inspection image or the reference image, and does not exist in the other image. If the standard defect were not provided, the inspection image and the reference image would be identical to each other. Accordingly, the gray level difference detected between the inspection image and the reference image at the position of the standard defect represents the gray level difference that should be detected between an image captured of the portion where the standard defect is formed and an image captured of the same portion but without forming the standard defect thereon when such images are captured from the surface of wafer 2 by image capturing unit 14. By creating the evaluated value under suitable inspection conditions, the target evaluated value can be obtained that represents the difference that should normally be present between the inspection image and the reference image at the position of the standard defect. The same applies to the size of the standard defect.

Standard defect extracting unit 70 receives the defect information from defect detection unit 24, judges whether the received defect information is the defect information concerning the standard defect by comparing the position information of the defect indicated by the received defect information with the position information of the standard defect stored in standard defect data storing unit 61, and extracts only the defect information concerning the standard defect.

Defect comparing unit 71 compares the information concerning the standard defect indicated by the defect information extracted by standard defect extracting unit 70 with the information of the standard defect stored in standard defect data storing unit 61, and judges the suitability of the detection sensitivity of inspection apparatus 1 based on the result of the comparison.

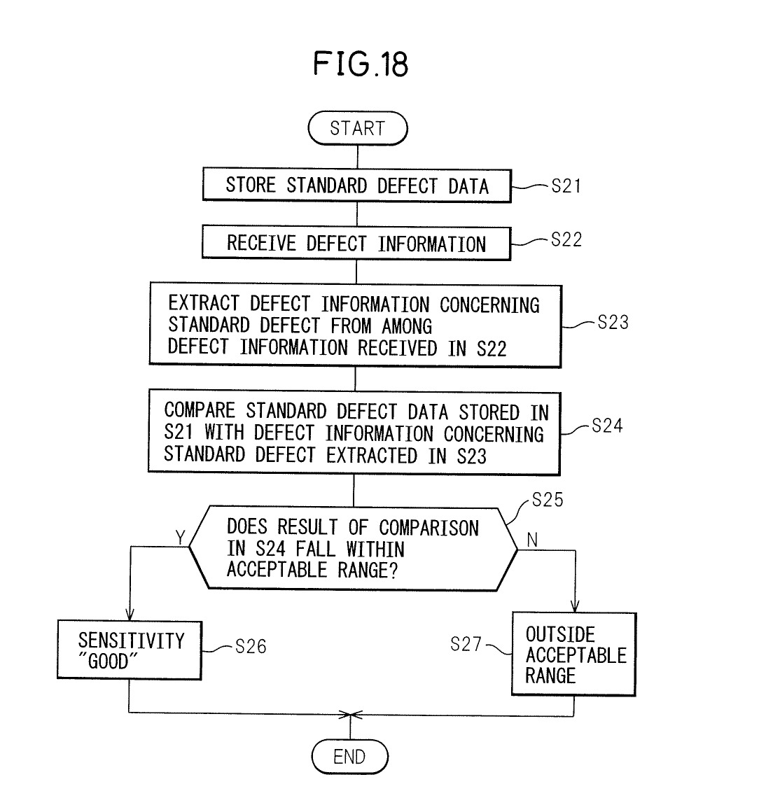

FIG. 18 is a flowchart of a detection sensitivity judging method according to a second embodiment of the present invention, showing how detection sensitivity judging unit 50 shown in FIG. 17 judges the suitability of the detection sensitivity of inspection apparatus 1.

In step S21, the standard defect data which is input via input unit 4 or created by standard defect data creating unit 72 is stored in standard defect data storing unit 61.

In step S22, standard defect extracting unit 70 receives the defect information from defect detection unit 24.

In step S23, standard defect extracting unit 70 extracts only the defect information concerning the standard defect from among the received defect information. In this case, standard defect extracting unit 70 reads out the position information of the standard defect stored in standard defect data storing unit 61, and judges whether the received defect information is the defect information concerning the standard defect by checking whether the position of the detected defect included in the received defect information matches the position information of the standard defect stored in standard defect data storing unit 61. Then, only the defect information concerning the standard defect is extracted and supplied to defect comparing unit 71.

In step S24, defect comparing unit 71 compares the information concerning the standard defect indicated by the defect information supplied from standard defect extracting unit 70 with the information of the standard defect stored in standard defect data storing unit 61, and judges the suitability of the detection sensitivity of inspection apparatus 1 based on the result of comparison.

For example, defect comparing unit 71 compares the number of standard defects that defect detection unit 24 detected in a prescribed region on wafer 2 with the number of standard defects that should exist in this prescribed region.

Or, defect comparing unit 71 compares the predefined kind of evaluated value contained in the defect information concerning a standard defect with the target evaluated value contained in the standard defect data concerning that standard defect.

If, in step S25, the result of the comparison in step S24 falls within a predetermined acceptable range, defect comparing unit 71 judges in step S26 that the detection sensitivity of inspection apparatus 1 is good, but if the result of the comparison falls outside the predetermined acceptable range, then it is judged in step S27 that the detection sensitivity of inspection apparatus 1 is outside the acceptable range.

For example, if the detection ratio, i.e., the ratio of the number of standard defects detected by defect detection unit 24 to the number of standard defects that should exist in the prescribed region, is lower than the minimum acceptable detection ratio, defect comparing unit 71 judges that the detection sensitivity of inspection apparatus 1 is outside the acceptable range; on the other hand, if the detection ratio is larger than the minimum acceptable detection ratio, it is judged that the detection sensitivity of inspection apparatus 1 is suitable.

Alternatively, if the difference between the evaluated value contained in the defect information concerning a standard defect and the target evaluated value contained in the standard defect data concerning that standard defect is larger than an acceptable value, defect comparing unit 71 judges that the detection sensitivity of inspection apparatus 1 is outside the acceptable range; on the other hand, if the difference is smaller than the acceptable value, it is judged that the detection sensitivity of inspection apparatus 1 is suitable.

The above embodiments of the present invention have been described by dealing with an inspection apparatus that detects defects appearing in an image captured of the surface of a sample by an optical image capturing means that uses illumination light. However, the present invention is not limited to this particular type of apparatus, but can also be applied to an inspection apparatus that detects defects appearing in an image captured of the surface of a sample by an electro-optic image capturing means such as a scanning electron microscope (SEM) that uses an electron beam.

Accordingly, the terms “optical system” and its “optical condition” as used in the appended claims refer not only to an optical system that handles light as a form of electromagnetic wave and the optical condition for the optical system, but also to an electro-optic system that handles an electron beam and the setup condition for the electro-optic system.

According to the present invention, in an inspection apparatus and inspection method for detecting a defect on an inspection surface of a sample by inspecting an image captured of the inspection surface, it becomes possible to judge whether the currently set inspection condition is suitable for the inspection of the actual sample to be inspected.

The present invention is applicable to an inspection apparatus and inspection method for detecting a defect on an inspection surface of a sample by inspecting an image captured of the inspection surface. More particularly, the invention is applicable to an inspection apparatus and inspection method for detecting a defect in a pattern formed on the surface of a substrate such as a semiconductor wafer, a photomask substrate, a liquid crystal display panel substrate, or a liquid crystal device substrate, based on an image captured of the surface of the substrate.

While the invention has been described with reference to specific embodiments chosen for purpose of illustration, it should be apparent that numerous modifications could be made thereto by those skilled in the art without departing from the basic concept and scope of the invention.

What is claimed is:

1. An inspection apparatus for detecting a defect on an inspection surface of a sample by inspecting an image captured of said inspection surface, comprising:
a defect detection unit for taking as an input the image captured of the inspection surface of said sample, and for detecting a defect appearing in said image;
a standard defect data storing unit for storing position information of a known standard defect formed in advance on the inspection surface of said sample to be inspected; and
a detection sensitivity judging unit for judging whether said defect detection unit can detect said standard defect located at the position that said position information stored in said standard defect data storing unit indicates in the image captured of the inspection surface of said sample containing said standard defect.

2. The inspection apparatus as claimed in claim 1, wherein said defect detection unit is configured so that when, in the image captured of the inspection surface of said sample, a gray level difference detected between corresponding portions that should normally be identical to each other satisfies a prescribed detection condition, said corresponding portions are detected as defect candidates, and
said detection sensitivity judging unit is configured to judge whether said standard defect can be detected by said defect detection unit, based on whether or not a standard defect gray level difference, which is a gray level difference occurring between a portion containing said standard defect and another portion in the image captured of the inspection surface of said sample containing said standard defect, satisfies said prescribed detection condition.

3. The inspection apparatus as claimed in claim 1, wherein said defect detection unit outputs defect information containing position information of said detected defect, and
said detection sensitivity judging unit judges whether said standard defect has been detected by said defect detection unit, by comparing the position information contained in the defect information concerning said defect that said defect detection unit detected from the image captured of the inspection surface of said sample containing said standard defect with the position information stored in said standard defect data storing unit.

4. An inspection method for detecting a defect on an inspection surface of a sample by inspecting an image captured of said inspection surface, comprising:
storing position information of a known standard defect formed in advance on the inspection surface of said sample to be inspected;
capturing the image of the inspection surface of said sample containing said standard defect; and
judging whether said standard defect located at the position that said stored position information indicates in the captured image can be detected.

5. The inspection method as claimed in claim 4, wherein when, in the image captured of the inspection surface of said sample, a gray level difference detected between corresponding portions that should normally be identical to each other satisfies a prescribed detection condition, said corresponding portions are detected as defect candidates, and
whether said standard defect can be detected is judged, based on whether or not a standard defect gray level difference, which is a gray level difference occurring between a portion containing said standard defect and another portion in the image captured of the inspection surface of said sample containing said standard defect, satisfies said prescribed detection condition.

6. The inspection method as claimed in claim 4, wherein defect information containing position information of said detected defect is created, and
whether said standard defect has been detected is judged, by comparing the position information of said defect detected from the image captured of the inspection surface of said sample containing said standard defect with the stored position information of said standard defect.
